(19) United States
(12) Patent Application Publication
(10) Pub. No.: US 2008/0173199 A1
(43) Pub. Date: Jul. 24, 2008

(54) APPARATUS AND METHOD FOR CHANGING A PRINTING PLATE OF A PRINTING PRESS

(75) Inventors: Peer DILLING, Friedberg (DE); Norbert Dylla, Stadtbergen (DE); Josef Hammer, Plauen (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 12/016,107

(22) Filed: Jan. 17, 2008

(30) Foreign Application Priority Data
Jan. 18, 2007 (DE) 10 2007 002 792.5

(51) Int. Cl. B41L 47/14

(52) U.S. Cl. 101/477; 101/485

(57) ABSTRACT

An apparatus and method for changing a printing plate of a printing unit of a printing press is disclosed. A printing unit of a printing press, in particular a web-fed printing press, has at least one printing couple, where the, or each, printing couple includes a plate cylinder, a transfer cylinder, an inking system as well as, preferably, a dampening system. Each printing couple is allocated a printing plate changing device for executing a partially automatic or fully automatic printing plate change on the plate cylinder of the respective printing couple. The plate cylinder of each printing couple can be displaced between two positions in such a way that in a first position the plate cylinder is engaged on the inking system and disengaged from the printing plate changing device and in a second position is engaged on the printing plate changing device and disengaged from the inking system.

This application claims the priority of German Patent Document No. 10 2007 002 792.5, filed Jan. 18, 2007, the disclosure of which is expressly incorporated by reference herein.

### BACKGROUND AND SUMMARY OF THE INVENTION

The invention relates to an apparatus and method for changing a printing plate of a printing unit of a printing press.

Printing units of web-fed printing presses have several printing couples, whereby each printing couple is comprised of at least one transfer cylinder, a plate cylinder, an inking system as well as a dampening system. Printing couples without dampening systems are also known. In addition, these types of printing units have impression cylinders, whereby an impression cylinder can cooperate with one or more transfer cylinders of different printing couples. Impression cylinders are also designated as satellite cylinders. In addition to printing units that have these types of impression cylinders, printing units are also known that have no impression cylinders, whereby, in the case of these types of printing units having no impression cylinders, the transfer cylinders of two printing couples roll off of one another. The transfer cylinders are also designated as blanket cylinders and the plate cylinders as engraving cylinders. The plate cylinders or the engraving cylinder carry printing plates.

In printing with a printing plate, a differentiation is made in principle between printing processes that operate, on the one hand, with printing plates that can be written on once and, on the other hand, with rewritable printing plates. The present invention relates to a printing unit of a printing press, which operates with printing plates that are embodied as printing plates that can be written on once. When a printing press has to be refitted for a new printing job, these types of printing plates must then be changed on the plate cylinders, whereby to do so so-called printing plate changing devices are used, which make a partially automatic or fully automatic printing plate change possible.

Printing units of web-fed rotary presses are increasingly being designed to be more compact, i.e., to have smaller dimensions. As a result of this, the available construction space on the printing units of a printing press, i.e., the space for positioning or arranging the inking systems, dampening systems and printing plate changing devices, is reduced. In addition, with printing units with more compact designs, access to the cylinders, namely to the plate cylinders as well as transfer cylinders, is impeded. In the case of printing units with smaller dimensions, integrating inking systems, dampening systems as well as printing plate changing devices into the printing press, while simultaneously guaranteeing simple access to the plate cylinders and transfer cylinders of the printing unit, consequently causes considerable difficulty.

Starting herefrom, the present invention is based on the objective of creating a novel printing unit of a printing press.

According to the invention, the printing plate of each printing couple can be displaced between two positions in such a way that in a first position the plate cylinder is engaged on the inking system and disengaged from the printing plate changing device and in a second position is engaged on the printing plate changing device and disengaged from the inking system.

The invention guarantees simple integration of the inking systems, dampening systems and printing plate changing devices into the printing units of printing presses having compact designs. Because of the movement of the plate cylinder relative to the inking system as well as relative to the printing plate changing device of a printing couple, it is possible to utilize the available construction space in an optimal manner and also guarantee simple access to the cylinders.

Preferred developments of the invention are yielded from the following description. Without being limited hereto, exemplary embodiments of the invention are explained in greater detail on the basis of the drawings.

### BRIEF DESCRIPTION OF THE DRAWINGS

FIG. 1 is a schematic representation of a printing couple of an inventive printing unit according to a first exemplary embodiment of the invention.

FIG. 2 is a schematic representation of a printing couple of an inventive printing unit according to a second exemplary embodiment of the invention.

### DETAILED DESCRIPTION OF THE DRAWINGS

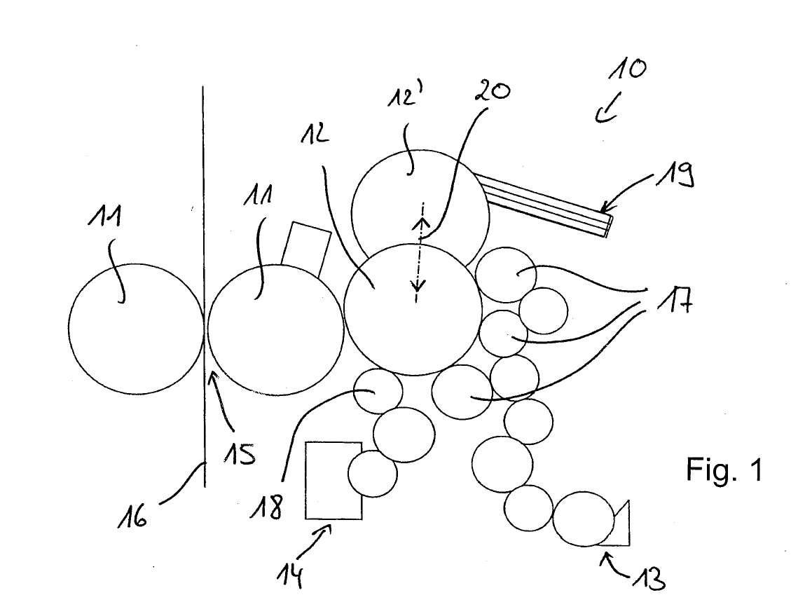

FIG. 1 shows a schematic section of an inventive printing unit in the area of a printing couple 10, whereby each printing couple is comprised of a transfer cylinder 11, a plate cylinder 12, an inking system 13 as well as a dampening system 14. The transfer cylinder 11 of the printing couple depicted in FIG. 1 rolls off on a transfer cylinder 11 of an adjacent printing couple forming a nip 15, whereby a print substrate web 16 that is to be printed is moved or conveyed through the nip 15. At least one printing plate is clamped on the plate cylinder 12 of each printing couple 10, whereby printing ink can be applied with the aid of the inking system 13 and dampening solution with the aid of the dampening system 14 to the, or each, printing plate that is clamped to the plate cylinder 12. According to FIG. 1, several ink form rollers 17 of the inking system 13 as well as a dampening form roller 18 of the dampening system 14 roll off on the plate cylinder 12.

A printing plate changing device 19 is also allocated to the printing couple 10 according to FIG. 1. The printing plate changing device 19 is used to partially automatically or even fully automatically execute a printing plate change on the plate cylinder 12 of the respective printing couple 10.

According to the invention, the plate cylinder 12 of each printing couple 10 of the inventive printing unit can be displaced between two positions, whereby in a first position, where the plate cylinder is identified by reference numeral 12, the plate cylinder is engaged on the inking system 13 as well as the dampening system 14 and disengaged from the printing plate changing device 19. In a second position, where the plate cylinder is identified by reference numeral 12′, the plate cylinder is engaged on the printing plate changing device 19 and disengaged from the inking system 13 as well as the dampening system 14. The first position of the plate cylinder 12 can be designated as the printing position and the second position of the plate cylinder 12′ as the equipping position. In the printing position, the circumference of the plate cylinder 12 is most widely available for inking-in. In the equipping position of the plate cylinder, the circumference of the plate cylinder 12′ is most widely available to the printing plate changing device 19.

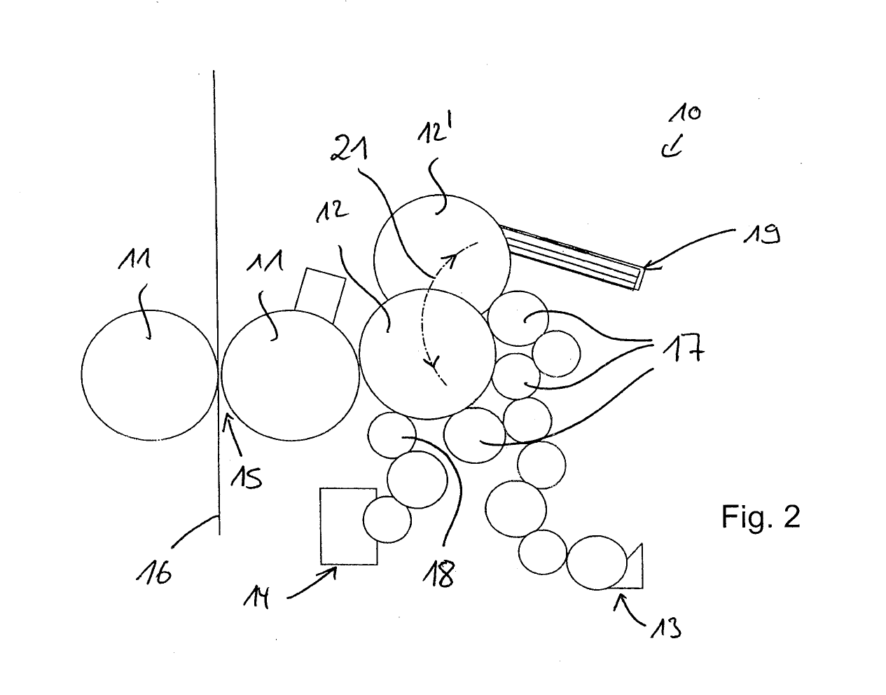

In the exemplary embodiment in FIG. 1, the plate cylinder 12 can be displaced along a straight path of motion 20. In contrast to this, FIG. 2 shows an exemplary embodiment, in which the plate cylinder 12 can be displaced along a path of motion shaped like the arc of a circle. It is conceivable that the plate cylinder 12 can be displaced along any curved paths of motion.

The inking system 13, the dampening system 14 as well as the printing plate changing device 19 of each printing couple 10 of the inventive printing unit are embodied to be stationary. Only the plate cylinder 12 can be displaced between the two positions in order to engage the plate cylinder either on the printing plate changing device 19 or on the inking system 13 as well as dampening system 14.

The plate cylinders 12 are preferably designed to be three-part, namely in such a way that the plate cylinders have a center cylinder bale, on which the printing plates are arranged, as well as two lateral bearing units.

The center cylinder bale can then be decoupled from the lateral bearing units in order to displace the cylinder bale along the respective path of motion. The bearing units are then stationary.

When displacing the plate cylinder 12, the position of a longitudinal center axis and thus the rotational axis of the plate cylinder 12 changes in the exemplary embodiments in FIGS. 1 and 2 exclusively in the radial direction as well as, where applicable, in the circumferential direction. On the other hand, the position of the plate cylinder 12 as seen in the axial direction remains unchanged when displacing the plate cylinder between the two positions.

### LIST OF REFERENCE NUMERALS

10 Printing unit

11 Transfer cylinder

12 Plate cylinder

13 Inking system

14 Dampening system

15 Nip

16 Print substrate web

17 Ink form roller

18 Dampening form roller

19 Printing plate changing device

20 Path of motion

21 Path of motion

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A printing unit of a printing press, having a printing couple, wherein the printing couple is comprised of a plate cylinder, a transfer cylinder, an inking system, and a dampening system, wherein the printing couple is allocated a printing plate changing device for executing a partially automatic or fully automatic printing plate change on the plate cylinder, and wherein the plate cylinder is displaceable between two positions such that in a first position the plate cylinder is engaged on the inking system and disengaged from the printing plate changing device and in a second position the plate cylinder is engaged on the printing plate changing device and disengaged from the inking system.

2. The printing unit according to claim 1, wherein the plate cylinder is displaceable along a straight path of motion essentially in a radial direction.

3. The printing unit according to claim 1, wherein the plate cylinder is displaceable along a curved path of motion essentially in a radial direction and a circumferential direction.

4. The printing unit according to claim 1, wherein the plate cylinder is displaceable along a path of motion shaped like an arc of a circle essentially in a radial direction and a circumferential direction.

5. The printing unit according to claim 1, wherein the inking system and the printing plate changing device are stationary.

6. The printing unit according to claim 1, wherein the plate cylinder is engaged in the first position on the inking system and the dampening system and is disengaged in the second position from the inking system and the dampening system.

7. A printing unit of a printing press, comprising:
a printing couple, wherein the printing couple includes:
a plate cylinder;
a transfer cylinder; and
an inking system; and
a printing plate changing device;
wherein the plate cylinder is displaceable between a first position where the plate cylinder is engaged on the inking system and disengaged from the printing plate changing device and a second position where the plate cylinder is engaged on the printing plate changing device and disengaged from the inking system.

8. The printing unit according to claim 7, wherein the printing plate changing device is positioned stationary with respect to the printing couple.

9. The printing unit according to claim 7, wherein the plate cylinder is displaceable a distance that is not greater than a diameter of the plate cylinder.

10. A method for changing a printing plate on a plate cylinder of a printing unit of a printing press, comprising the steps of:
moving the plate cylinder from a first position where the plate cylinder is engaged on the inking system and disengaged from the printing plate changing device to a second position where the plate cylinder is engaged on the printing plate changing device and disengaged from the inking system; and
changing a printing plate on the plate cylinder by the printing plate changing device after the plate cylinder is moved to the second position.

11. The method according to claim 10, further comprising the step of maintaining the printing plate changing device in a stationary position with respect to the inking system.

12. The method according to claim 10, wherein the plate cylinder is moved from the first position to the second position a distance that is not greater than a diameter of the plate cylinder.
